(19) United States
(12) Patent Application Publication
(10) Pub. No.: US 2025/0058658 A1
(43) Pub. Date: Feb. 20, 2025

(54) UNMANNED AERIAL VEHICLE CHARGING SYSTEM

(71) Applicant: Quanta Computer Inc., Taoyuan City (TW)

(72) Inventors: Yi-Chun HSIAO, Taoyuan City (TW); Hung-Sheng HSUEH, Taoyuan City (TW); Sheng-Chih LU, Taoyuan City (TW)

(21) Appl. No.: 18/504,350

(22) Filed: Nov. 8, 2023

(30) Foreign Application Priority Data
Aug. 18, 2023 (TW) 112131145

(51) Int. Cl. B60L 53/12; B60L 3/12; B60L 53/30; B64F 1/36; H02J 50/10

(52) U.S. Cl. CPC B60L 53/12; B60L 3/12; B60L 53/30; B64F 1/362; H02J 50/10; B60L 2200/10; B64U 10/13

(57) ABSTRACT

A unmanned aerial vehicle charging system for charging an unmanned aerial vehicle is provided. The unmanned aerial vehicle charging system includes a platform, a wireless charging coil assembly, a first electromagnet, a second electromagnet, and a third electromagnet. The wireless charging coil assembly is disposed on the platform. A first virtual line and a second virtual line pass through the wireless charging coil assembly, wherein the first virtual line is substantially perpendicular to the second virtual line. The first, second, and third electromagnets are disposed on the platform. The first electromagnet and the second electromagnet are located on opposite sides of the first virtual line. The second electromagnet and the third electromagnet are located on opposite sides of the second virtual line.

### CROSS REFERENCE TO RELATED APPLICATIONS

The present application claims priority of Taiwan Patent Application No. 112131145, filed Aug. 18, 2023, which is incorporated by reference herein in its entirety.

### BACKGROUND OF THE INVENTION

### Field of the Invention

The application relates in general to an unmanned aerial vehicle charging system, and in particular, to an unmanned aerial vehicle charging system that can position precisely to enhance the charging efficiency.

### Description of the Related Art

With the technological advancements, unmanned vehicle technology has matured in recent years. In general, there are five types of unmanned vehicles: unmanned ground vehicles (UGV), unmanned aerial vehicles (UAV), unmanned surface vehicles (USV), unmanned underwater vehicles (UUV), and unmanned spacecraft.

In recent years, the market of the unmanned aerial vehicle in the world has been greatly increased. The unmanned aerial vehicle becomes an important tool in the commercial, government and consumer applications, and it is widely applied in various fields.

### BRIEF SUMMARY OF INVENTION

An embodiment of the invention provides an unmanned aerial vehicle charging system for charging an unmanned aerial vehicle. The unmanned aerial vehicle charging system includes a platform, a wireless charging coil assembly, a first electromagnet, a second electromagnet, and a third electromagnet. The wireless charging coil assembly is disposed on the platform. A first virtual line and a second virtual line pass through the wireless charging coil assembly, wherein the first virtual line is substantially perpendicular to the second virtual line. The first, second, and third electromagnets are disposed on the platform. The first electromagnet and the second electromagnet are located on opposite sides of the first virtual line. The second electromagnet and the third electromagnet are located on opposite sides of the second virtual line.

In some embodiments, the first electromagnet, the second electromagnet, and the third electromagnet are controlled by pulse-width modulation.

In some embodiments, the first electromagnet, the second electromagnet, and the third electromagnet create magnetic fields with the same frequency.

In some embodiments, the unmanned aerial vehicle charging system further comprises a first sensor and a second sensor, and the first sensor and the second sensor are disposed on the unmanned aerial vehicle to measure the magnetic field created by the first electromagnet, the second electromagnet, and the third electromagnet.

In some embodiments, the first sensor is configured to measure magnetic flux in a first direction, a second direction, and a third direction, the first direction is substantially perpendicular to the platform, the second direction is substantially perpendicular to the first direction, and the third direction is substantially perpendicular to the first direction and the second direction. The second sensor is configured to measure magnetic flux in the first direction and a fourth direction, and the fourth direction is opposite to the second direction.

In some embodiments, each of the first sensor and the second sensor is a 3D Hall sensor.

In some embodiments, the unmanned aerial vehicle charging system further comprises a processor and a switch, the processor is electrically connected to the first sensor, and the switch is electrically connected to the processor and the first sensor. When the density of magnetic flux measured by the first sensor is greater than or equal to a starting value, the switch transmits a signal to the processor, and the processor starts to read the sensing value of the first sensor.

In some embodiments, when the sensing value of the first sensor obtained by the processor is greater than or equal to a first predetermined value, the processor determines that the unmanned aerial vehicle is in a position corresponding to the wireless charging coil assembly.

In some embodiments, the processor is electrically connected to a coil in the unmanned aerial vehicle, and is enabled to detect the current of the coil to determine the charging efficiency of the unmanned aerial vehicle.

In some embodiments, when the sensing value of the first sensor obtained by the processor is less than a second predetermined value, the processor stops reading the sensing value of the first sensor, wherein the second predetermined value is less than the starting value.

### BRIEF DESCRIPTION OF DRAWINGS

The invention can be more fully understood by reading the subsequent detailed description and examples with references made to the accompanying drawings, wherein:

FIG. 1 is a schematic diagram of an unmanned aerial vehicle and an unmanned aerial vehicle charging system according to an embodiment of the invention;

FIG. 2 is a schematic diagram of a magnetic field with a specific frequency generated by pulse-width modulation (PWM) according to an embodiment of the invention;

FIG. 3A is a schematic diagram of a first sensor according to an embodiment of the invention;

FIG. 3B is a schematic diagram of a second sensor according to an embodiment of the invention;

FIG. 4 is a schematic diagram of a circuit assembly according to an embodiment of the invention; and

FIG. 5 is a flow chart of the steps to dock an unmanned aerial vehicle on an unmanned aerial vehicle charging system according to an embodiment of the invention.

### DETAILED DESCRIPTION OF INVENTION

The making and using of the embodiments of the unmanned aerial vehicle charging system are discussed in detail below. It should be appreciated, however, that the embodiments provide many applicable inventive concepts that can be embodied in a wide variety of specific contexts. The specific embodiments discussed are merely illustrative of specific ways to make and use the embodiments, and do not limit the scope of the disclosure.

Unless defined otherwise, all technical and scientific terms used herein have the same meaning as commonly understood by one of ordinary skill in the art to which this invention belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

The following disclosure provides many different embodiments, or examples, for implementing different features of the subject matter provided. Specific examples of solutions and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. Furthermore, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

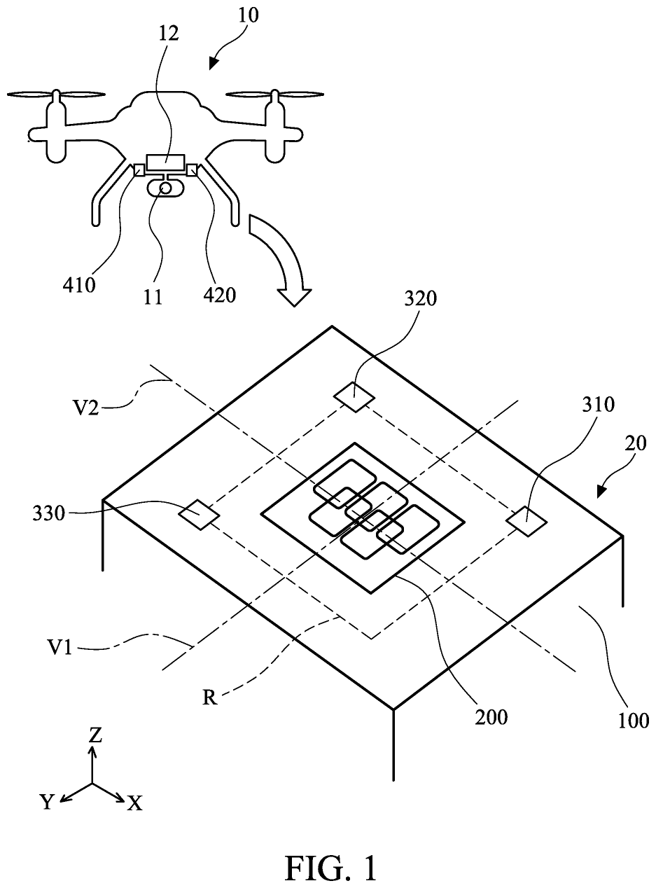

Referring to FIG. 1, an unmanned aerial vehicle 10 can dock on an unmanned aerial vehicle charging system 20 according to an embodiment of the invention. When the unmanned aerial vehicle 10 is docked, the unmanned aerial vehicle charging system 20 can supply power to a power storage member (such as a battery) of the unmanned aerial vehicle 10, so that the unmanned aerial vehicle 10 can have enough power to do the next voyage. The unmanned aerial vehicle 10 can be configured to monitor a farm (for example, it can include a camera 11), spray liquid or gas (for example, it can spray water or drug on the farmland), and/or transport goods, but it is not limited thereto.

As shown in FIG. 1, the unmanned aerial vehicle charging system 20 primarily includes a platform 100, a wireless charging coil assembly 200, a first electromagnet 310, a second electromagnet 320, a third electromagnet 330, a first sensor 410, and a second sensor 420.

The platform 100 has a top surface that is substantially flat. Therefore, when the unmanned aerial vehicle 10 docks on the platform 100, it can be disposed thereon steadily without tipping due to the tilt. The wireless charging coil assembly 200 is disposed on the platform 100, and it can be inductive coupled with coil 12 on the unmanned aerial vehicle 10. Thus, when the unmanned aerial vehicle 10 docks on the platform 100 and the coil 12 on the unmanned aerial vehicle 10 corresponds to the wireless charging coil assembly 200 on the platform 100, the unmanned aerial vehicle charging system 20 can supply power to the unmanned aerial vehicle 10 in a wireless manner.

The first electromagnet 310, the second electromagnet 320, and the third electromagnet 330 can be disposed on the platform 100 and adjacent to the wireless charging coil assembly 200. The first sensor 410 and the second sensor 420 can be disposed on the unmanned aerial vehicle 10 and used to measure the magnetic fields created by the first electromagnet 310, the second electromagnet 320, and the third electromagnet 330. Therefore, the first electromagnet 310, the second electromagnet 320, the third electromagnet 330, the first sensor 410, and the second sensor 420 can be used to position the location or the orientation of the unmanned aerial vehicle 10 relative to the platform 100 and/or the wireless charging coil assembly 200.

In particular, a first virtual line V1 and a second virtual line V2 can pass through the wireless charging coil assembly 200, and first virtual line V1 and the second virtual line V2 are substantially perpendicular to each other. The first electromagnet 310 and the second electromagnet 320 are disposed on the opposite sides of the first virtual line V1, and the second electromagnet 320 and the third electromagnet 330 are disposed on the opposite sides of the second virtual line V2. In this embodiment, the first electromagnet 310, the second electromagnet 320, and the third electromagnet 330 are disposed on the different corners of a virtual rectangle R surrounding the wireless charging coil assembly 200.

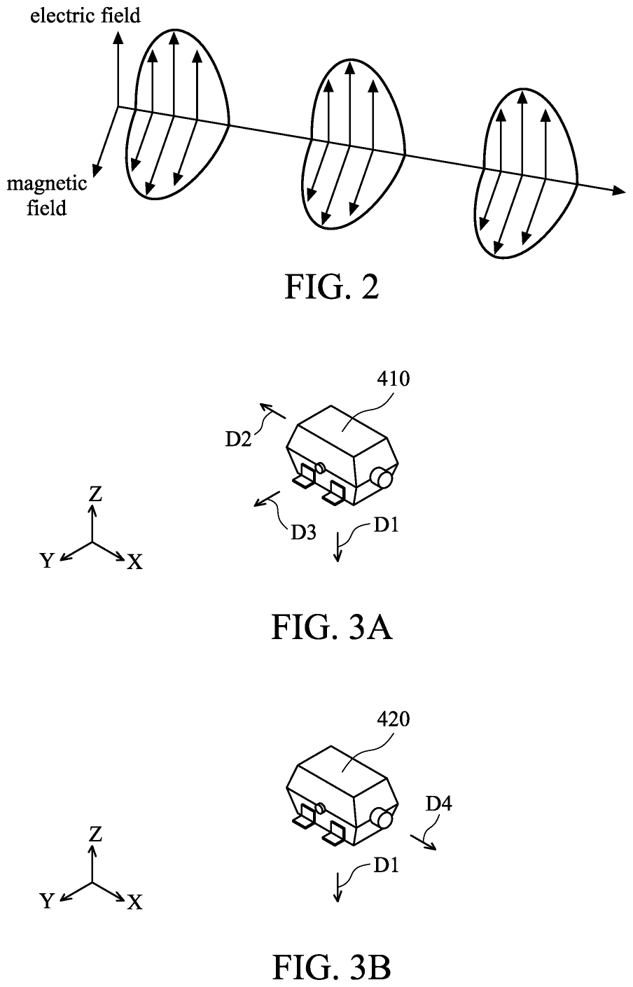

The first electromagnet 310, the second electromagnet 320, and the third electromagnet 330 can be controlled by pulse-width modulation (PWM) technology. Thus, as shown in FIG. 2, the first electromagnet 310, the second electromagnet 320, and the third electromagnet 330 create a specific magnetic field. The first sensor 410 and the second sensor 420 on the unmanned aerial vehicle 10 can measure this specific magnetic field, and does not influenced by the magnetic field of other apparatus in the environment. In this embodiment, the first electromagnet 310, the second electromagnet 320, and the third electromagnet 330 create magnetic fields with the same frequency, but it is not limited thereto. For example, the aforementioned specific magnetic field may be from 10 Hz to 100 Hz.

Each of the first sensor 410 and the second sensor 420 can be a 3D Hall sensor. When the unmanned aerial vehicle 10 approaches the unmanned aerial vehicle charging system 20, the first sensor 410 and the second sensor 420 can measure the magnetic flux in the X-axis, the Y-axis, and the Z-axis, so that determination can be made as to whether the unmanned aerial vehicle 10 still needs to move in the aforementioned direction in order to make the coil 12 correspond to the wireless charging coil assembly 200.

As shown in FIG. 3A and FIG. 3B, in this embodiment, the first sensor 410 is set to measure the magnetic flux in a first direction D1, the magnetic flux in a second direction D2, and the magnetic flux in a third direction D3, and the second sensor 420 is set to measure the magnetic flux in the first direction D1 and a fourth direction D4. The first direction D1 is substantially perpendicular to the platform 100, the second direction D2 is substantially perpendicular to the first direction D1, the third direction D3 is substantially perpendicular to the first direction D1 and the second direction D2, and the fourth direction D4 is opposite to the second direction D2.

Since the first sensor 410 and the second sensor 420 measure the magnetic flux in specific directions, and the electromagnets are disposed on all sides of the wireless charging coil assembly 200, it can be ensured that the location and the orientation of the unmanned aerial vehicle 10 correctly corresponds when the unmanned aerial vehicle 10 docks on the unmanned aerial vehicle charging system 20, and the better charging efficiency can be achieved.

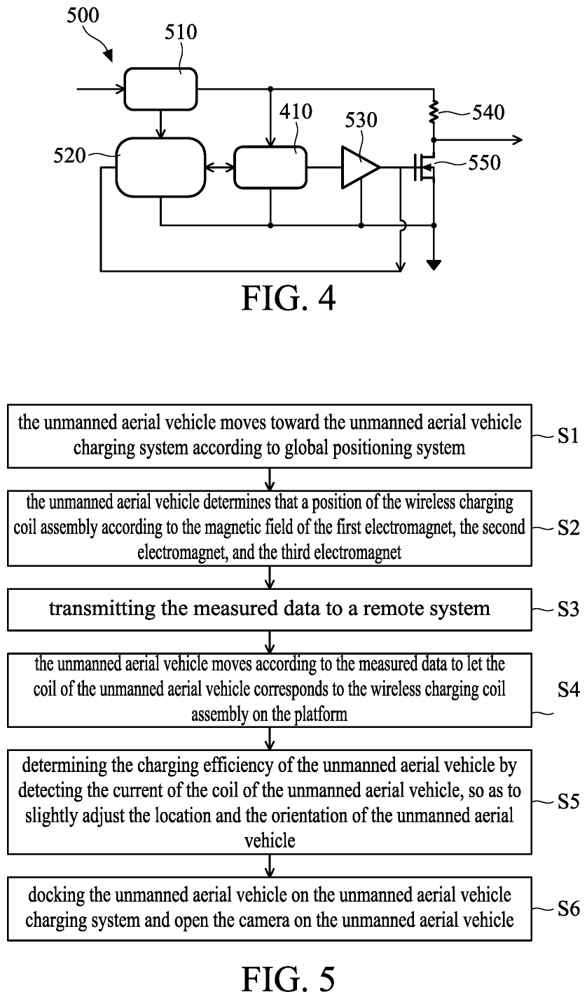

Referring to FIG. 4, in this embodiment, the unmanned aerial vehicle charging system 20 can further include a circuit assembly 500 disposed on the unmanned aerial vehicle 10, and the circuit assembly 500 can be electrically connected to the first sensor 410 and the second sensor 420. The connection relationship of the first sensor 410 and the members in the circuit assembly 500 are shown in FIG. 4. It should be noted that, the second sensor 420 and the members in the circuit assembly 500 can include the same connection relationship, so that the features thereof are not repeated in the interest of brevity.

The circuit assembly 500 includes a converter 510, a processor 520, an operational amplifier 530, a resistor 540, and a switch 550. The converter 510 can be electrically connected to the power storage member in the unmanned aerial vehicle 10, and can be also electrically connected to the processor 520, the operational amplifier 530, and the switch 550. Therefore, the power from the power storage member can be converted by the converter 510 and then supply to the processor 520, the operational amplifier 530, and the switch 550. For example, the converter 510 can be a DC/DC converter.

The first sensor 410 and the second sensor 420 are electrically connected to the processor 520 and the operational amplifier 530, and the operational amplifier 530 is electrically connected to the switch 550. When the unmanned aerial vehicle 10 flies, the first sensor 410 and the second sensor 420 continuously measure the magnetic flux in the first direction D1, the second direction D2, the third direction D3, and/or the fourth direction D4. When the magnetic flux measured by the first sensor 410 or the second sensor 420 is less than a starting value, it can be determined that there is a far distance between the unmanned aerial vehicle 10 and the unmanned aerial vehicle charging system 20, the switch can be closed accordingly, and the processor 520 does not read the sensing value of the first sensor 410 or the second sensor 420 at this time. Thus, the power of the unmanned aerial vehicle 10 can be saved, and the distance of the voyage of the unmanned aerial vehicle 10 can be increased.

When the density of the magnetic flux measured by the first sensor 410 or the second sensor 420 in any direction is greater than or equal to the starting value, the switch 550 can turn on and transmit a signal to the processor 520, and the processor 520 can start to read the sensing value in this direction measured by the first sensor 410 or the second sensor 420. The processor 520 can determine whether the unmanned aerial vehicle 10 should continue to move in this direction according to the obtained value. When the sensing value of the first sensor 410 or the second sensor 420 obtained by the processor 520 is greater than or equal to a first predetermined value, the processor 520 determines that the coil 12 on the unmanned aerial vehicle 10 already corresponds to the position of the wireless charging coil assembly 200, and the processor 520 can control the unmanned aerial vehicle 10 to stop moving in this direction.

For example, when the density of the magnetic flux measured by the first sensor 410 is greater than or equal to 240G (the starting value), the switch 550 can turn on and the processor 520 can start to read the density of the magnetic flux in the first direction D1. When the density of the magnetic flux in the first direction D1 is greater than or equal to 400G (the first predetermined value), the processor 520 can determine that the coil 12 on the unmanned aerial vehicle 10 already corresponds to the position of the wireless charging coil assembly 200, and can control the unmanned aerial vehicle 10 to stop moving in the first direction D1.

The aforementioned staring value and the first predetermined value are examples and are not limited thereto. Moreover, the switch 550 can turn on independently in each direction, so that the processor 520 can independently read the magnetic flux in the first direction D1, the second direction D2, the third direction D3, and/or the fourth direction D4. For example, when the density of the magnetic flux in the first direction D1 is greater than the starting value and the density of the magnetic flux in the second direction D2 is not greater than the starting value, the switch 550 can let the processor 520 merely read the magnetic flux in the first direction D1. When both of the density of the magnetic flux in the first direction D1 and the second direction D2 are greater than the starting value, the switch 550 can let the processor 520 read the magnetic flux in the first direction D1 and the second direction D2 simultaneously.

In an embodiment, after the processor 520 starting to read the sensing value of the first sensor 410 or the second sensor 420, the unmanned aerial vehicle 10 may deviate or move away from the unmanned aerial vehicle charging system 20 due to the heading or other reasons, thus the sensing value of the first sensor 410 or the second sensor 420 may be less than the starting value again. At this time, the processor 520 can still read the sensing value of the first sensor 410 or the second sensor 420. When the sensing value of the first sensor 410 or the second sensor 420 is less than a second value, which is less than the starting value (for example, 150G), the processor 520 can determine that the unmanned aerial vehicle 10 is far away from the unmanned aerial vehicle charging system 20 and stops reading the sensing value of the first sensor 410 or the second sensor 420.

The whole process of docking the unmanned aerial vehicle 10 on the unmanned aerial vehicle charging system 20 is discussed below. Referring to FIG. 5 and the corresponding FIGS. 1-4, first, the unmanned aerial vehicle 10 can move toward the unmanned aerial vehicle charging system 20 according to global positioning system (GPS) (step S1). In a specific embodiment, the unmanned aerial vehicle 10 can store the GPS coordinates of the unmanned aerial vehicle charging system 20 in advance. Second, the unmanned aerial vehicle 10 can determine that position of the wireless charging coil assembly 200 according to the magnetic field of the first electromagnet 310, the second electromagnet 320, and the third electromagnet 330 (step S2). That is, the unmanned aerial vehicle 10 can use the first sensor 410 and the second sensor 420 to measure the magnetic flux.

In some embodiments, the measured data can be transmitted to a remote system (such as a computer or a server) (step S3). The remote system can transmit a signal to the processor 520 to control the fly of the unmanned aerial vehicle 10. In an embodiment, the step S3 is a selective step.

Subsequently, the unmanned aerial vehicle 10 can move according to the measured data to let the coil 12 of the unmanned aerial vehicle 10 corresponds to the wireless charging coil assembly 200 on the platform 100 (step S4). In some embodiments, the processor 520 of the unmanned aerial vehicle 10 is further electrically connected to the coil 12, and can determine the charging efficiency of the unmanned aerial vehicle 10 by detecting the current of the coil 12. Therefore, the processor 520 can further slightly adjust the location and the orientation of the unmanned aerial vehicle 10 before the unmanned aerial vehicle 10 docks on the unmanned aerial vehicle charging system 20 to further increase the charging efficiency (step S5).

Finally, when the unmanned aerial vehicle 10 docks on the unmanned aerial vehicle charging system 20, the camera 11 can be still opened or enabled to monitor forward when charging (step S6). In an embodiment, the step S6 is a selective step.

In summary, an embodiment of the invention provides an unmanned aerial vehicle charging system for charging an unmanned aerial vehicle. The unmanned aerial vehicle charging system includes a platform, a wireless charging coil assembly, a first electromagnet, a second electromagnet, and a third electromagnet. The wireless charging coil assembly is disposed on the platform, a first virtual line and a second virtual line pass through the wireless charging coil assembly, and the first virtual line is substantially perpendicular to the second virtual line. The first, second, and third electromagnets are disposed on the platform. The first electromagnet and the second electromagnet are located on opposite sides of the first virtual line. The second electromagnet and the third electromagnet are located on opposite sides of the second virtual line.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, compositions of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. Moreover, the scope of the appended claims should be accorded the broadest interpretation so as to encompass all such modifications and similar arrangements.

While the invention has been described by way of example and in terms of preferred embodiment, it should be understood that the invention is not limited thereto. On the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. An unmanned aerial vehicle charging system for charging an unmanned aerial vehicle, comprising:
a platform;
a wireless charging coil assembly, disposed on the platform, wherein a first virtual line and a second virtual line pass through the wireless charging coil assembly, and the first virtual line is substantially perpendicular to the second virtual line;
a first electromagnet, disposed on the platform;
a second electromagnet, disposed on the platform, wherein the first electromagnet and the second electromagnetic are disposed on opposite sides of the first virtual line; and
a third electromagnet, disposed on the platform, wherein the second electromagnet and the third electromagnet are disposed on opposite sides of the second virtual line.

2. The unmanned aerial vehicle charging system as claimed in claim 1, wherein the first electromagnet, the second electromagnet, and the third electromagnet are controlled by pulse-width modulation.

3. The unmanned aerial vehicle charging system as claimed in claim 1, wherein the first electromagnet, the second electromagnet, and the third electromagnet create magnetic fields with the same frequency.

4. The unmanned aerial vehicle charging system as claimed in claim 1, wherein the unmanned aerial vehicle charging system further comprises a first sensor and a second sensor, and the first sensor and the second sensor are disposed on the unmanned aerial vehicle to measure the magnetic field created by the first electromagnet, the second electromagnet, and the third electromagnet.

5. The unmanned aerial vehicle charging system as claimed in claim 4, wherein the first sensor is configured to measure magnetic flux in a first direction, a second direction, and a third direction, and the first direction is substantially perpendicular to the platform, the second direction is substantially perpendicular to the first direction, and the third direction is substantially perpendicular to the first direction and the second direction, wherein the second sensor is configured to measure magnetic flux in the first direction and a fourth direction, and the fourth direction is opposite to the second direction.

6. The unmanned aerial vehicle charging system as claimed in claim 4, wherein each of the first sensor and the second sensor is a 3D Hall sensor.

7. The unmanned aerial vehicle charging system as claimed in claim 4, wherein the unmanned aerial vehicle charging system further comprises a processor and a switch, and the processor is electrically connected to the first sensor, and the switch is electrically connected to the processor and the first sensor, wherein when the density of magnetic flux measured by the first sensor is greater than or equal to a starting value, the switch transmits a signal to the processor, and the processor starts to read a sensing value of the first sensor.

8. The unmanned aerial vehicle charging system as claimed in claim 7, wherein when the sensing value of the first sensor obtained by the processor is greater than or equal to a first predetermined value, the processor determines that the unmanned aerial vehicle is in a position corresponding to the wireless charging coil assembly.

9. The unmanned aerial vehicle charging system as claimed in claim 8, wherein the processor is electrically connected to a coil in the unmanned aerial vehicle, and is enabled to detect a current of the coil to determine a charging efficiency of the unmanned aerial vehicle.

10. The unmanned aerial vehicle charging system as claimed in claim 7, wherein when the sensing value of the first sensor obtained by the processor is less than a second predetermined value, the processor stops reading the sensing value of the first sensor, wherein the second predetermined value is less than the starting value.
